(19) United States
(12) Patent Application Publication
(10) Pub. No.: US 2016/0056538 A1
(43) Pub. Date: Feb. 25, 2016

(54) WIRELESS COMMUNICATION APPARATUS AND NFC ANTENNA STRUCTURE

(71) Applicant: RAINSUN CO., LTD, Taoyuan County (TW)

(72) Inventors: YUAN-HAN CHAN, TAICHUNG CITY (TW); CHENG-LEI LEE, TAOYUAN COUNTY (TW)

(21) Appl. No.: 14/465,145

(22) Filed: Aug. 21, 2014

(51) Int. Cl. H01Q 7/00

(52) U.S. Cl. CPC H01Q 7/00

(57) ABSTRACT

A wireless communication apparatus includes an electronic device and an NFC antenna structure having a sheet and an antenna disposed on a surrounding area of the sheet. The antenna has an outer connecting pad, an inner connecting pad, and a radiating body. The outer and inner connecting pads are respectively arranged adjacent to the outer and inner edges of the surrounding area. The radiating body has a continuously spiral shape, and two ends of the radiating body are respectively connected to the outer and inner connecting pads. The radiating body is extended from the outer connecting pad to spirally travel on the surrounding area and forms at least three loops. The outer and inner connecting pads of the antenna respectively and detachably abut against the two pins of the electronic device to achieve electrical connection between the electronic device and the antenna of the NFC antenna structure.

### BACKGROUND OF THE DISCLOSURE

1. Field of the Disclosure

The instant disclosure relates to an antenna structure; in particular, to a wireless communication apparatus and a near field communication (NFC) antenna structure.

2. Description of Related Art

Please refer to FIG. 1, which shows a planar view of a conventional NFC antenna structure 1a. The NFC antenna structure 1a is a one-side antenna structure and includes a substrate 11a and an antenna 12a formed on two opposite surfaces of the substrate 11a. The antenna 12a has two connecting pads 121a arranged adjacent to each other, a plurality of radiating bodies 122a connected to the connecting pads 121a, and a plurality of connecting segments 123a. The one-side antenna structure means that the connecting pads 121a are formed on the same surface of the substrate 11a.

Specifically, the connecting pads 121a and the radiating bodies 122a are formed on the top surface of the substrate 11a, and the connecting segments 123a are formed on the bottom surface of the substrate 11a. The radiating bodies 122a are not continuous in one strip, so the substrate 11a needs to have a plurality of thru-holes 111a respectively arranged at the discontinued ends of the radiating bodies 122a. A conductive material is filled in the thru-holes 111a to connect the radiating bodies 122a to the connecting segments 123a, such that any two adjacent discontinued ends of the radiating bodies 122a are electrically connected by the corresponding connecting segments 123a and the conductive material filled in the corresponding thru-holes 111a.

However, the thru-holes 111a and the connecting segments 121a necessary for the conventional NFC antenna structure 1a is complicated and increases the cost of the manufacturing process of the conventional NFC antenna structure 1a.

To achieve the abovementioned improvement, the inventors strive through industrial experience and academic research to present the instant disclosure, which can provide additional improvement as mentioned above.

### SUMMARY OF THE DISCLOSURE

One embodiment of the instant disclosure provides a wireless communication apparatus and an NFC antenna structure for solving the problems generated by the thru-holes and the connecting segments of the conventional NFC antenna structure.

The wireless communication apparatus of the instant disclosure comprises: an electronic device having two pins arranged adjacent to each other; and a near field communication (NFC) antenna structure, comprising: a sheet having a first surface and an opposite second surface, wherein the first surface defines a surrounding area and a center area surrounded by the surrounding area; and an antenna disposed on the surrounding area of the first surface of the sheet, wherein the antenna has an outer connecting pad, an inner connecting pad, and a radiating body, the outer connecting pad is arranged adjacent to the outer edge of the surrounding area, the inner connecting pad is arranged adjacent to the inner edge of the surrounding area, the radiating body has a continuously spiral shape, two ends of the radiating body are respectively connected to the outer connecting pad and the inner connecting pad, wherein the radiating body is extended from the outer connecting pad to spirally travel on the surrounding area and forms N loops of the same width, and N is a positive integer and is greater than or identical to three; wherein the outer connecting pad and the inner connecting pad of the antenna respectively and detachably abut against the two pins of the electronic device to achieve electrical connection between the electronic device and the antenna of the NFC antenna structure.

Preferably, the distance between the pins is greater than or identical to the shortest distance between the outer connecting pad and the inner connecting pad, a distance between any two adjacent loops of the radiating body is defined as a predetermined distance, and the relative position of the outer connecting pad and the inner connecting pad satisfies the formula: D=NP+(N−1)W, wherein D is the shortest distance between the outer connecting pad and the inner connecting pad, P is the predetermined distance, and W is the width of any portion of the radiating body.

The near field communication (NFC) antenna structure of the instant disclosure comprises: a sheet having a first surface and an opposite second surface, wherein the first surface defines a surrounding area and a center area surrounded by the surrounding area; and an antenna disposed on the surrounding area of the first surface of the sheet, wherein the antenna has an outer connecting pad, an inner connecting pad, and an radiating body, the outer connecting pad is arranged adjacent to the outer edge of the surrounding area, the inner connecting pad is arranged adjacent to the inner edge of the surrounding area, the radiating body has a continuously spiral shape, two ends of the radiating body are respectively connected to the outer connecting pad and the inner connecting pad, wherein the radiating body is extended from the outer connecting pad to spirally travel on the surrounding area and forms N loops of the same width, and N is a positive integer and is greater than or identical to three.

Based on the above, the distance between the outer connecting pad and the inner connecting pad can be adjusted by the construction design of the antenna, thus the NFC antenna structure of the instant embodiment is provided without any thru-hole so as to facilitate manufacturing, thereby further reducing the cost of the NFC antenna structure (or the electronic device).

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a perspective view showing a conventional NFC antenna structure;

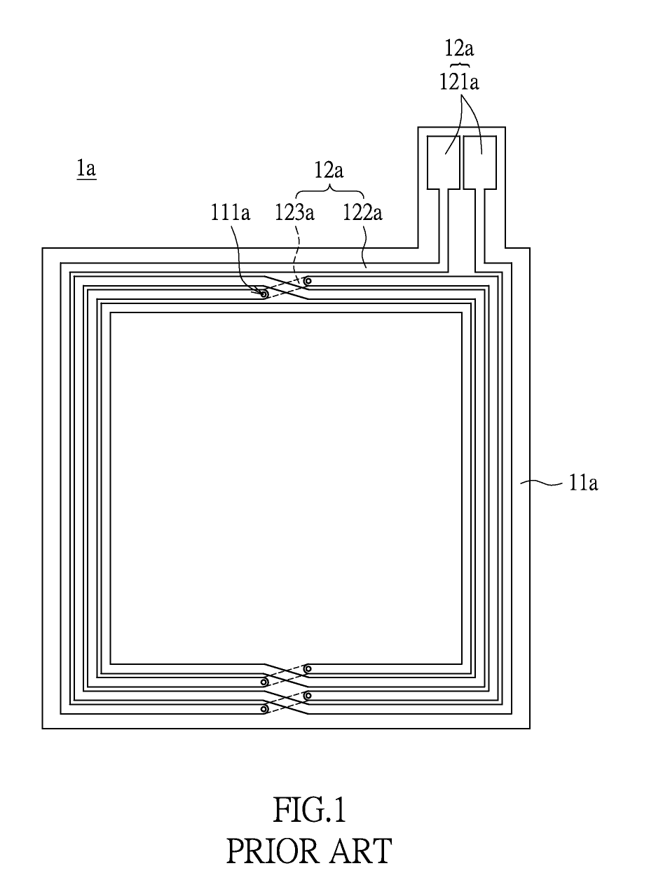

FIG. 2 is a perspective view showing a wireless communication apparatus according to the instant disclosure;

FIG. 3 is an exploded view of the wireless communication apparatus of FIG. 2;

FIG. 4 is a front view showing the NFC antenna structure of FIG. 3; and

FIG. 5 is an enlarged view of FIG. 4.

### DETAILED DESCRIPTION OF THE PREFERRED EMBODIMENTS

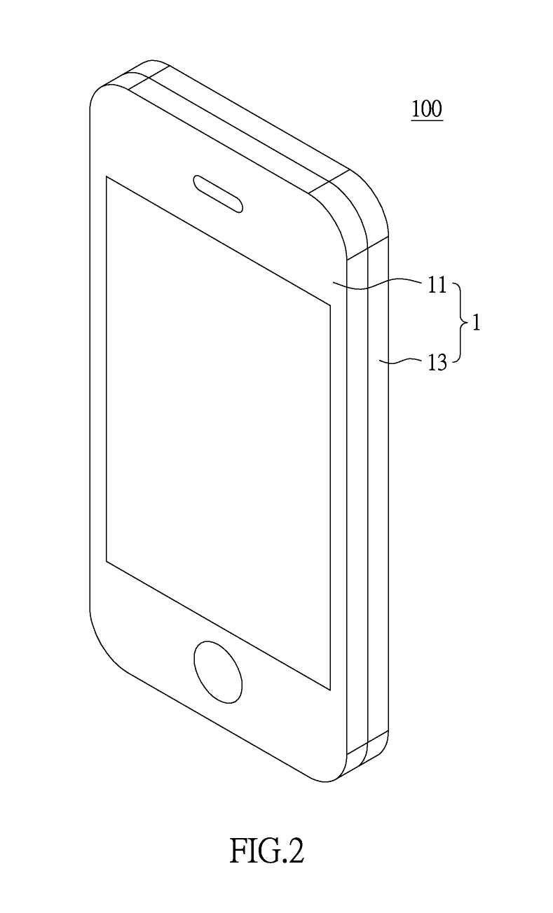

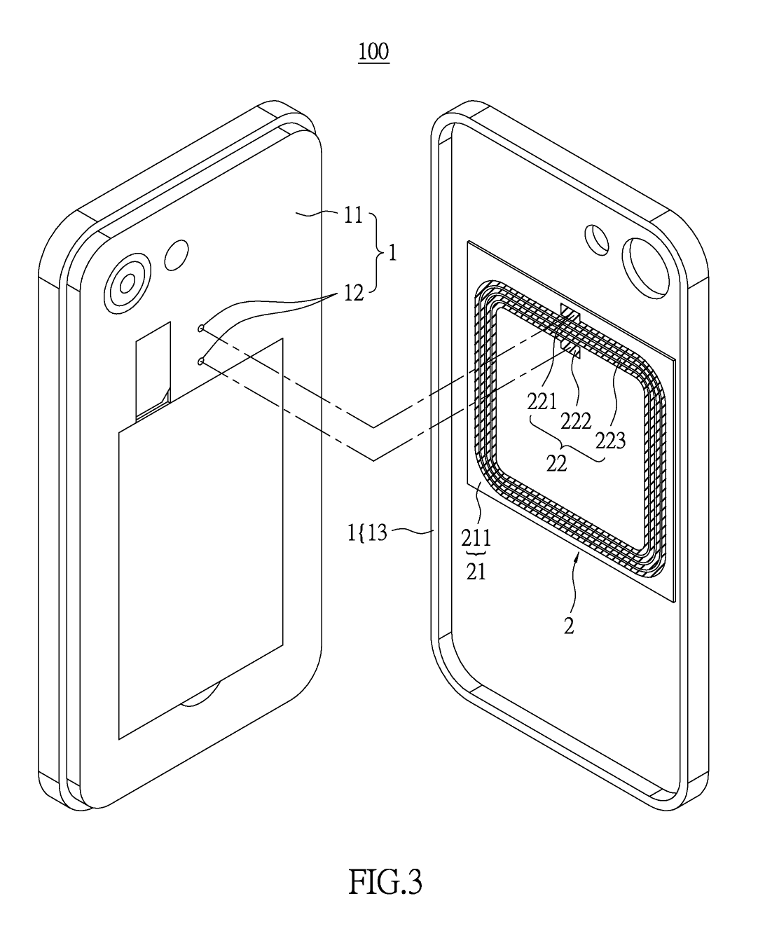

Please refer to FIGS. 2 and 3, which show an embodiment of the instant disclosure. References are hereunder made to the detailed descriptions and appended drawings in connection with the instant disclosure. However, the appended drawings are merely shown for exemplary purposes, rather than being used to restrict the scope of the instant disclosure.

The instant embodiment provides a wireless communication apparatus 100, such as cell phone, smart phone, or tablet PC. The wireless communication apparatus 100 includes an electronic device 1 and a near field communication (NFC) antenna structure 2. The NFC antenna structure 2 is detachably installed in the electronic device 1.

The electronic device 1 has a main body 11, two adjacent pins 12, and a cover 13. The main body 11 may have a casing (not labeled), a LCD module (not labeled) installed on the casing, a circuit board (not labeled) arranged in the casing, and a plurality of electronic components (not labeled) mounted on the circuit board. The pins 12 are arranged on the backside of the main body 11 (i.e., one side of the main body 11 away from the LCD module as shown in FIG. 3), and the pins 12 are electrically connected to the circuit board and the electronic components of the main body 11. The cover 13 is installed on the backside of the main body 11 to accommodate the pins 12 in the electronic device 1.

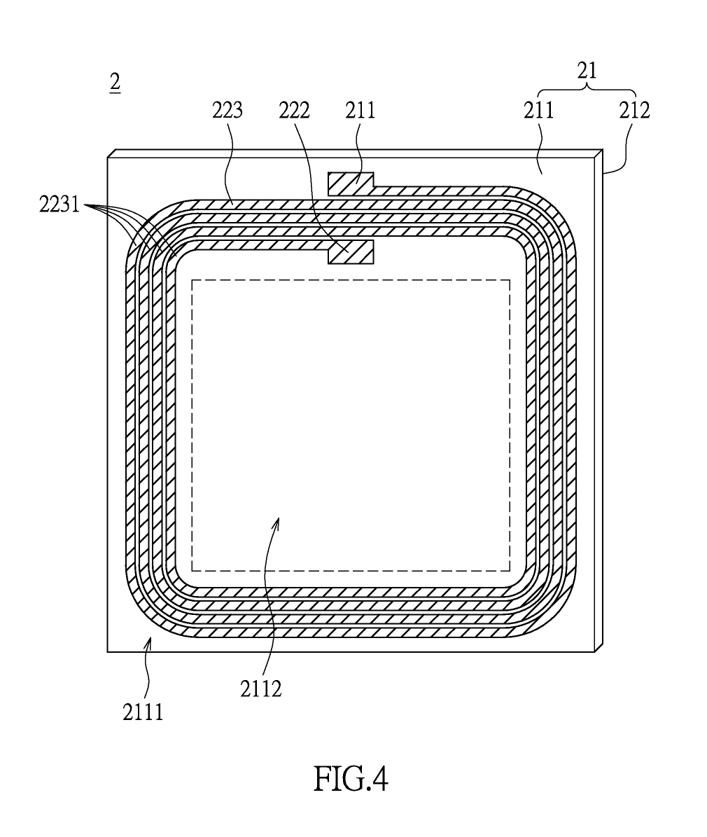

The NFC antenna structure 2 is a one-side antenna structure and is arranged between the main body 11 and the cover 13. The NFC antenna structure 2 has a sheet 21 and an antenna 22 disposed on the sheet 21. The sheet 21 is an insulating and soft substrate made of polymer material, but is not limited thereto. The sheet 21 has a first surface 211 (i.e., the top surface of the sheet 21 as shown in FIG. 4) and an opposite second surface 212 (i.e., the bottom surface of the sheet 21 as shown in FIG. 4). The first surface 211 defines a surrounding area 2111 and a center area 2112 surrounded by the surrounding area 2111.

Specifically, the surrounding area 2111 of the instant embodiment is square-ring shaped, but is not limited thereto. The surrounding area 2111 defines an outer edge (not labeled) and an inner edge (i.e., the dotted line as shown in FIG. 4) arranged inside the outer edge. The outer edge of the surrounding area 2111 is equivalent to the outer edge of the first surface 211.

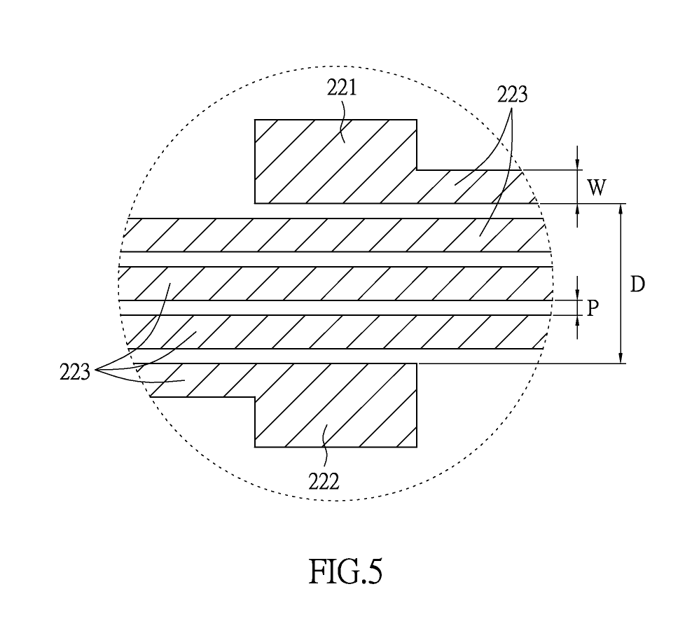

Please refer to FIGS. 4 and 5. The antenna 22 is disposed on the surrounding area 2111 of the first surface 211 of the sheet 21, and the center area 2112 is provided without any antenna 22. The antenna 22 has an outer connecting pad 221, an inner connecting pad 222, and a radiating body 223.

Moreover, the one-side antenna structure of the instant embodiment means that the outer connecting pad 221 and the inner connecting pad 222 are disposed on the same surface of the sheet 21 (i.e., the first surface 211 of the sheet 21), thus the outer connecting pad 221 and the inner connecting pad 222 of the NFC antenna structure 2 can face the same direction to abut the pins 12 of the electronic device 1.

The outer connecting pad 221 is arranged adjacent to the outer edge of the surrounding area 2111, and the inner connecting pad 222 is arranged adjacent to the inner edge of the surrounding area 2111. The radiating body 223 has a continuously spiral shape, and two ends of the radiating body 223 are respectively connected to the right end of the outer connecting pad 221 and the left end of the inner connecting pad 222. Specifically, the radiating body 223 is extended from the outer connecting pad 221 to spirally travel on the surrounding area 2111 and forms N loops of the same width (i.e., the width W of FIG. 5), and N is a positive integer and is greater than or identical to three. That is to say, the radiating body 223 passes between the outer connecting pad 221 and the inner connecting pad 222 (N−1) times. N in the instant embodiment is four, but is not limited thereto.

It should be noted that the radiating body 223 is provided with the same width to avoid increasing of the impedance generated from different widths of the radiating body, thereby having a better efficiency.

In more detail, the outer connecting pad 221 and the inner connecting pad 222 of the instant embodiment are rectangular, and the width and the length of the outer connecting pad 221 are respectively identical to the width and the length of the inner connecting pad 222. The width of the outer connecting pad 221 is greater than the width W of any portion of the radiating body 223. A distance between any two adjacent loops of the radiating body 223 is defined as a predetermined distance P, and the predetermined distance P is smaller than or identical to the width W of any portion of the radiating body 223.

Moreover, the distance between the outer connecting pad 221 and the adjacent loop formed by the radiating body 223 is equal to the predetermined distance P. The distance between the inner connecting pad 222 and the adjacent loop formed by the radiating body 223 is equal to the predetermined distance P. The edges of the outer connecting pad 221 and the inner connecting pad 222 facing each other are respectively aligned with the portions of the radiating body 223 to which they are connected to. Based on the above, the relative position of the outer connecting pad 221 and the inner connecting pad 222 satisfies the formula: D=NP+(N−1)W, where D is a shortest distance between the outer connecting pad 221 and the inner connecting pad 222.

Additionally, a distance between the pins 12 of the electronic device 1 is greater than or identical to the shortest distance D between the outer connecting pad 221 and the inner connecting pad 222, such that the outer connecting pad 221 and the inner connecting pad 222 of the NFC antenna structure 2 can respectively abut against the pins 12 of the electronic device 1 to achieve electrical connection between the electronic device 1 and the antenna of the NFC antenna structure 2.

In other words, the shortest distance D between the outer connecting pad 221 and the inner connecting pad 222 (or the distance between the pins 12) can be adjusted in the construction design of the antenna 22, thus the NFC antenna structure 2 of the instant embodiment is provided without any thru-hole so as to facilitate manufacturing for reducing the cost of the NFC antenna structure 2 (or the electronic device 1).

Besides, each loop of the radiating body 223 has four circular corners 2231 respectively arranged at the four corners of the surrounding area 2111. That is to say, each loop of the radiating body 223 has four circular corners 2231, and a sum of the central angles of the circular corners 2231 of each loop of the radiating body 223 is approximately 360 degrees.

Thus, the radiating body 223 is provided with the circular corners 2231 to avoid the increasing of the impedance generated from right-angle corners. Moreover, the number of the circular corner 2231 of each loop of the radiating body 223 is provided with a predetermined number (i.e., four) for avoiding energy loss.

### [The Possible Effect of the Instant Disclosure]

In summary, the distance between the outer connecting pad and the inner connecting pad (or the distance between the pins of the electronic device) can be adjusted in the construction design of the antenna, thus the NFC antenna structure of the instant embodiment is provided without any thru-hole so as to facilitate manufacturing, thereby further reducing the cost of the NFC antenna structure (or the electronic device).

Moreover, the radiating body of the instant disclosure is provided with the same width to avoid increasing of the impedance generated from different widths of the radiating body, thereby having a better efficiency. The radiating body of the instant disclosure is provided with the circular corners to avoid the increasing of the impedance generated from right angle corners. Moreover, the number of the circular corner of each loop of the radiating body is provided with a predetermined number (i.e., four) for avoiding energy loss.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A wireless communication apparatus, comprising:
an electronic device having two pins arranged adjacent to each other; and
a near field communication (NFC) antenna structure, comprising:
a sheet having a first surface and an opposite second surface, wherein the first surface defines a surrounding area and a center area surrounded by the surrounding area; and
an antenna disposed on the surrounding area of the first surface of the sheet, wherein the antenna has an outer connecting pad, an inner connecting pad, and a radiating body, the outer connecting pad is arranged adjacent to the outer edge of the surrounding area, the inner connecting pad is arranged adjacent to the inner edge of the surrounding area, the radiating body has a continuously spiral shape, two ends of the radiating body are respectively connected to the outer connecting pad and the inner connecting pad, wherein the radiating body is extended from the outer connecting pad to spirally travel on the surrounding area and forms N loops of the same width, and N is a positive integer and is greater than or identical to three;
wherein the outer connecting pad and the inner connecting pad of the antenna respectively and detachably abut against the two pins of the electronic device to achieve electrical connection between the electronic device and the antenna of the NFC antenna structure.

2. The wireless communication apparatus as claimed in claim 1, wherein a distance between the pins is greater than or identical to the shortest distance between the outer connecting pad and the inner connecting pad, a distance between any two adjacent loops of the radiating body is defined as a predetermined distance, and the relative position of the outer connecting pad and the inner connecting pad satisfies the formula: D=NP+(N−1)W, wherein D is the shortest distance between the outer connecting pad and the inner connecting pad, P is the predetermined distance, and W is the width of any portion of the radiating body.

3. The wireless communication apparatus as claimed in claim 2, wherein each loop of the radiating body has four circular corners, and a sum of the central angles of the circular corners of each loop of the radiating body is substantially 360 degrees.

4. The wireless communication apparatus as claimed in claim 2, wherein N is four, the surrounding area of the first surface is square-ring shaped, and each loop of the radiating body has four circular corners respectively arranged at the four corners of the surrounding area.

5. The wireless communication apparatus as claimed in claim 2, wherein the predetermined distance is smaller than or identical to the width of any portion of the radiating body, the width of the outer connecting pad is identical to the width of the inner connecting pad, and the width of the outer connecting pad is greater than the width of any portion of the radiating body.

6. A near field communication (NFC) antenna structure, comprising:
a sheet having a first surface and an opposite second surface, wherein the first surface defines a surrounding area and a center area surrounded by the surrounding area; and
an antenna disposed on the surrounding area of the first surface of the sheet, wherein the antenna has an outer connecting pad, an inner connecting pad, and a radiating body, the outer connecting pad is arranged adjacent to the outer edge of the surrounding area, the inner connecting pad is arranged adjacent to the inner edge of the surrounding area, the radiating body has a continuously spiral shape, two ends of the radiating body are respectively connected to the outer connecting pad and the inner connecting pad, wherein the radiating body is extended from the outer connecting pad to spirally travel on the surrounding area and forms N loops of the same width, and N is a positive integer and is greater than or identical to three.

7. The NFC antenna structure as claimed in claim 6, wherein a distance between any two adjacent loops of the radiating body is defined as a predetermined distance, and the relative position of the outer connecting pad and the inner connecting pad satisfies the formula: D=NP+(N−1)W, wherein D is the shortest distance between the outer connecting pad and the inner connecting pad, P is the predetermined distance, and W is the width of any portion of the radiating body.

8. The NFC antenna structure as claimed in claim 7, wherein each loop of the radiating body has four circular corners, and a sum of the central angles of the circular corners of each loop of the radiating body is substantially 360 degrees.

9. The NFC antenna structure as claimed in claim 7, wherein N is four, the surrounding area of the first surface is square-ring shaped, and each loop of the radiating body has four circular corners respectively arranged at the four corners of the surrounding area.

10. The NFC antenna structure as claimed in claim 7, wherein the predetermined distance is smaller than or identical to the width of any portion of the radiating body, the width of the outer connecting pad is identical to the width of the inner connecting pad, and the width of the outer connecting pad is greater than the width of any portion of the radiating body.
